(19) United States
(12) Patent Application Publication
(10) Pub. No.: US 2012/0297962 A1
(43) Pub. Date: Nov. 29, 2012

(54) KEYTAR HAVING A DOCK FOR A TABLET COMPUTING DEVICE

(75) Inventors: John E. O'Donnell, Ft. Lauderdale, FL (US); David Gill, North Providence, RI (US); Brian R. Shim, Providence, RI (US)

(73) Assignee: ALESIS, L.P., Cumberland, RI (US)

(21) Appl. No.: 13/478,474

(22) Filed: May 23, 2012

Related U.S. Application Data
(63) Continuation-in-part of application No. 13/463,462, filed on May 3, 2012.
(60) Provisional application No. 61/489,876, filed on May 25, 2011.

(51) Int. Cl. G10H 7/00; G10H 1/00

(52) U.S. Cl. 84/645; 84/601

(57) ABSTRACT

A keytar is disclosed. The keytar has a keyboard body having a front, back, left side, and right side. A piano-style keyboard with a number of keys is on the front of the keyboard body. A neck extends from either the left or the right side and the left side of the keyboard body. A number of drum pads are on the front of the keyboard body. An electronic circuit is electrically connected to the drum pads and keys. The electronic circuit is configured and arranged to scan the state of each of the drum pads and keys and generate a MIDI note signal corresponding to the state each drum pad and keys and transmit the MIDI note signal to the tablet computer. The keytar may further include an accelerometer to provide music effects.

### CROSS-REFERENCE TO RELATED APPLICATION

This patent document claims priority to earlier filed U.S. Provisional Application Ser. No. 61/489,876, filed May 25, 2011, and is a continuation-in-part of U.S. application Ser. No. 13/463,462, filed on May 3, 2012, the entire contents of which are incorporated herein by reference.

### BACKGROUND

1. Technical Field

The present patent document relates generally electronic music instruments and controllers, and more particularly to an improved electronic keyboard instrument, called a “keytar”.

2. Background of the Related Art

The “keytar” is a musical instrument with a piano-style keyboard that is worn with a strap like a guitar. It can have a built-in sound generator, or merely be a controller for an external sound generator.

The keytar is a relatively obscure but still established music instrument. A history of it can be found on Wikipedia: http://en.wikipedia.org/wiki/Keytar.

Although keytars have all the versatility of a synthesizer, many musicians find using a keyboard to generate other types of sounds awkward. Because the keyboard keys abut one another, it is easy to strike multiple or the incorrect key. So, for instance, if a musician desires to play percussive sound using the keyboard keys, using a slap-style of play similar to a bass player is impractical.

Also, many keyboards include function controls, like a pitch-bend control, to apply effects to the sound of the keyboard. However, these controls require the use of two hands to operate the controls. Keytars suffer a disadvantage to typical synthesizer keyboard because keytars are played with one hand, like a guitar is strummed. Although the musician's second hand is free to operate other functions controls, many musicians find this arrangement awkward at best.

Therefore, there is a perceived need in the industry for an improved keytar that provides the ability to generate a wider range of sounds and provide better easier controls to operate the keyboard functions, which can lead to better showmanship for stage acts.

Furthermore, tablet computers, such as the Apple iPad brand tablet computer, have emerged as popular devices for creating and composing music. Although a tablet computer's touch screen offers some interesting possibilities for the control and creation of music, these touch screens are inherently small when compared to the control surface of a piano. Also, the touch interface requires users to learn a new way of playing and composing music. That is, the touch control interface does not permit a user to interact with a full size piano keyboard in the same manner as operating the respective music instrument.

Therefore, there is a perceived need in the industry for an interface for a tablet computer that permits a user to compose and play music as one would with a traditional instrument.

### SUMMARY

The present invention solves the problems of the prior art by providing an improved keytar that includes a dock for including a tablet computing device (or just tablet computer), such as an Apple iPad brand tablet computer, a series of optimally placed drum pads and may also include an accelerometer configured to generate MIDI continuous controller values.

The controller uses the tablet computer's touch screen and digital signal processing (“DSP”) engine to control and produce the sound. Use of the tablet computer's inherent components reduces the cost of the controller because these components do not need to be included in the controller.

In addition to the piano-style keyboard, the improved keytar adds additional functionality to this instrument for greater performance and control possibilities. The included percussion pads enable drum sounds that can be more easily played on the instrument. Furthermore, the placement of the drum pads has been optimized to permit “slap bass” style of playing, which musicians find intuitive, and leads to dynamic performances. Specifically, these drum pads allow the musician to trigger drum sounds in a more natural and realistic way than using piano keys. The triggering method is very similar to how a bass player slaps the strings with his thumb and plucks with this fingers on a bass guitar. Thus, it is a very natural way of triggering percussive sounds.

Also, included is an accelerometer to determine if the instrument is tilted relative to the horizontal, in which case a MIDI continuous control is generated to modulate or affect the sound. For instance, the MIDI continuous control signal can be set to change the timbre, volume, or other parameter of a sound, offering new performance possibilities. As can be readily understood, the use of an accelerometer frees the musician to concentrate on playing the keytar. A side-effect of the accelerometer is also that it forces the musician to rock and tile the keytar which leads to a more physically expressive style of playing that entertains live audiences.

### BRIEF DESCRIPTION OF THE DRAWINGS

These and other features, aspects, and advantages of the present invention will become better understood with reference to the following description, appended claims, and accompanying drawings where:

FIG. 1 is a front and right side perspective view of an improved keytar with a tablet computing device docked in the keytar;

FIG. 2 is a front and right-side perspective view of the improved keytar with the tablet computing device removed from the keytar

FIG. 3 is a rear plan view of an improved keytar;

FIG. 4 is a cross-section view through line 4-4 of FIG. 3;

FIG. 5 is a cross-section view through line 5-5 of FIG. 3; and

FIG. 6 is a diagram of the electrical operation of the improved keytar.

### DESCRIPTION OF THE PREFERRED EMBODIMENT

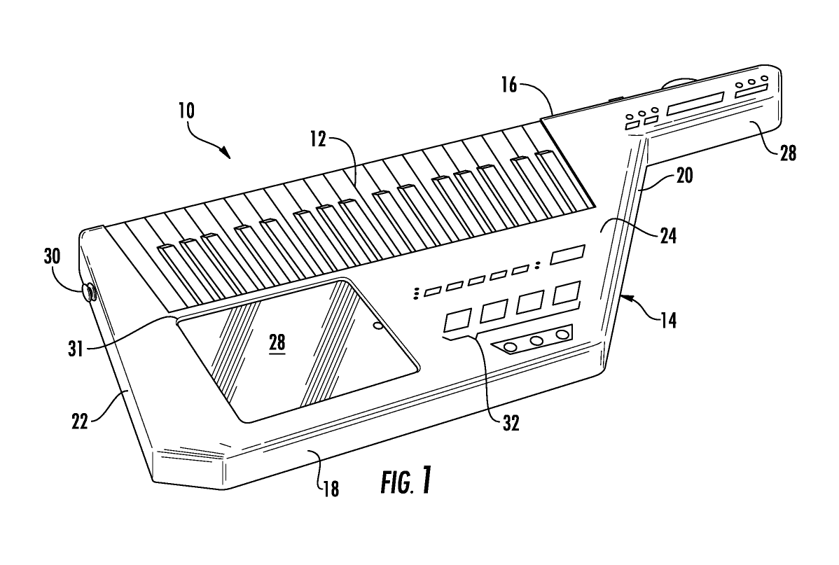

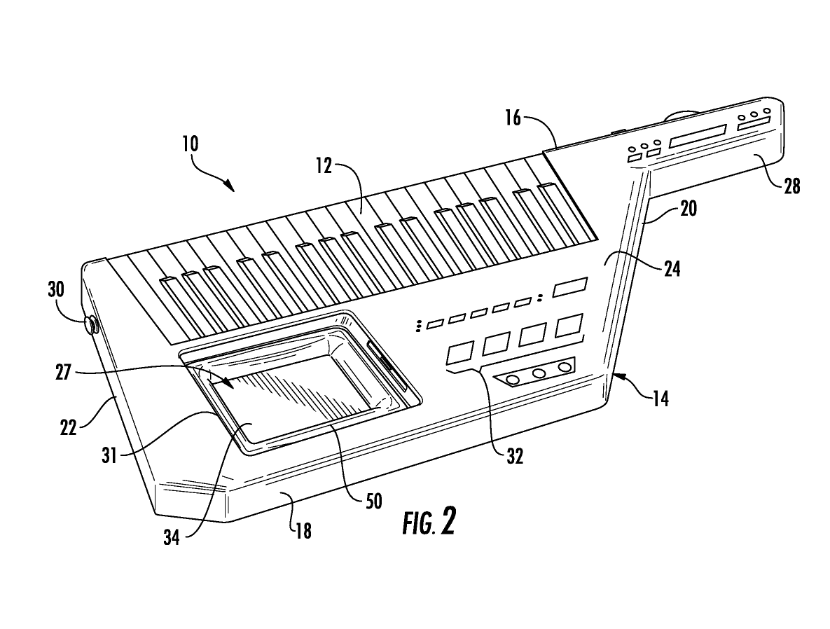

Referring now to FIGS. 1 and 2, an embodiment of the improved keytar is shown generally at 10. The improved keytar includes a piano-style keyboard 12 in a keyboard body 14. The keyboard body 14 generally includes a top 16, bottom 18, left side 20, right side 22, front 24 and back 25. For purposes of orienting the reader, the keyboard body 12 is described in relationship to a musician wearing the keytar 10. Thus the front 24 of the keyboard body 14 faces outwards from the musician, the back of the keyboard body 14 rests against the musician, and the left side 20 and right side 22 of the keyboard body 14 are on the left hand and right hand sides, respectively, of the musician.

A cavity 27 is formed in the keyboard body 14 and is sized and dimensioned to hold a tablet computer 29, such as an Apple iPad brand tablet computer 29. Optional spacers and sleeves may be used to allow tablet computers 29 of different dimensions to be inserted into the cavity 27. An edge 31 defines an opening through the keytar body 14 and into the cavity 27. The edge 31 also forms lip 33 that overlaps the tablet computer 29.

The keyboard body 14 includes a neck 28 extending from the left side 20 of the keyboard body 14, which functions as a handle for the musician's left hand and includes additional controls to change the functions of the keytar 10. A fastening point 35 for a guitar strap to make the keytar 10 easier to carry may be located on the neck 28 or back 25 of the keyboard body 12 as is known in the art. The second fastening point 30 for the strap is located on the right side 22 of the keyboard body 14. It is important to note that the keytar 10 described and shown herein is set up for right-handed musicians, meaning the musician's right hand is primarily used to play the keyboard 12 keys. One skilled in the art would find it elementary to reverse the structures to make a keytar 10 for left-handed musicians.

Located the keytar body 14, so as to be easily accessible by the musician's right hand, are a number of drum pads 32. The drum pads 32, as will be more fully described below, permit the musician to play percussion sounds with the keytar 10. These drum pads 32 may also be configured to trigger other percussion sounds, such as cymbals too.

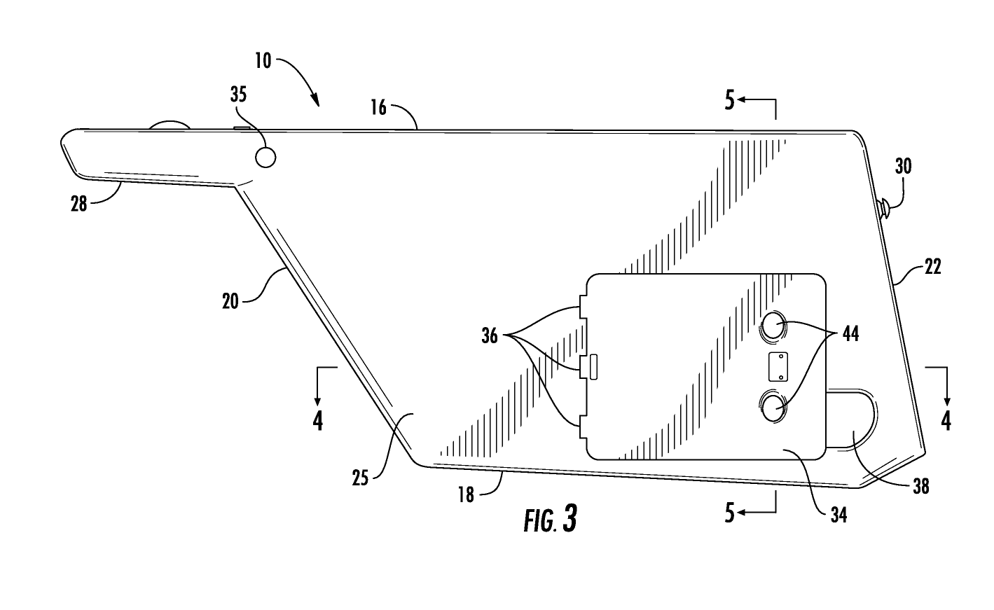

Referring to FIG. 3, the tablet computer is secured within the keytar body by a door 34. The door 34 is hinged by one or more hinges 36 on the back 25 of the keytar body 14. Although three hinges 36 are depicted, fewer or more hinges 36 may be added as is known in the art. A locking mechanism secures the door 34 shut against the keytar body 14.

A recess 38 is provided on the rear of the keytar body 14 to allow access to the headphone output and to manipulate buttons on the tablet computer 29, such as power, rotation lock, volume and mute switches.

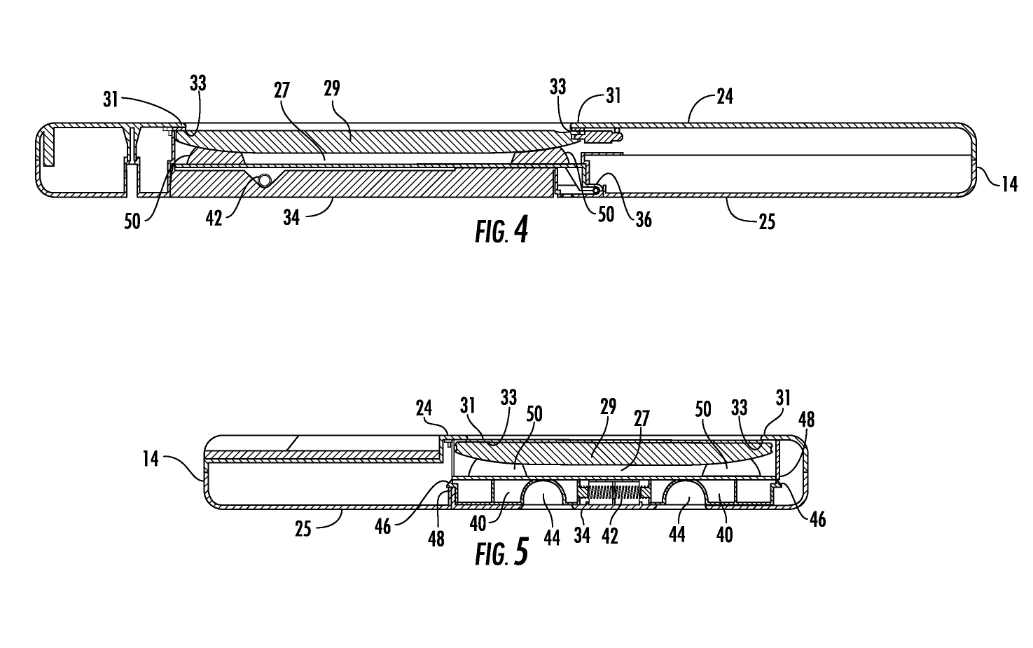

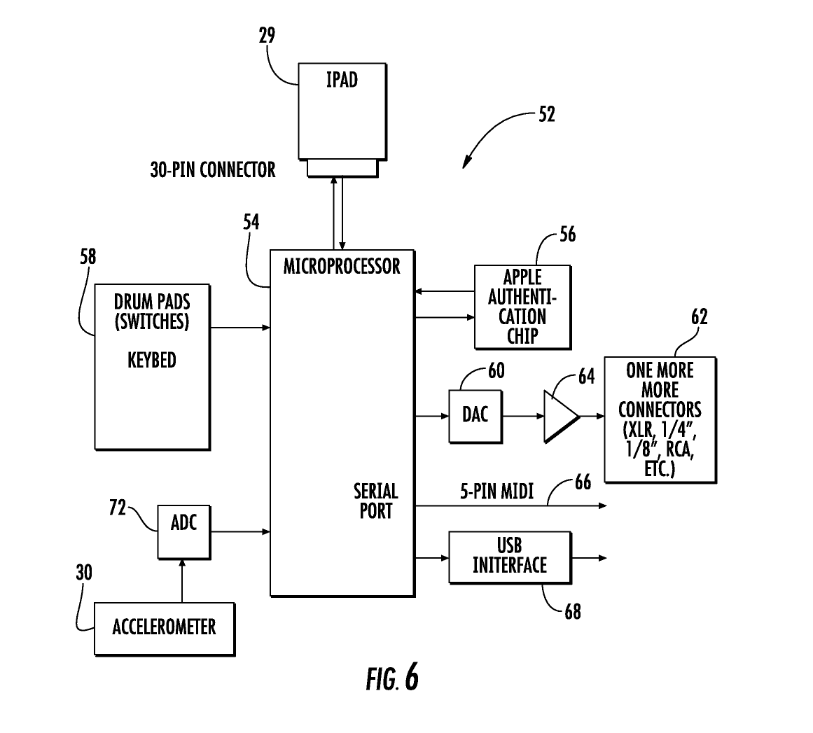

Referring to FIGS. 4-5, the tablet computer 29 is recessed inside the keytar body 14 within the cavity 27, the lip 33 providing the musician tactile feedback when they have strayed off of the touch screen of the tablet computer 29. As shown, the tablet computer 29 is recessed 4.5 mm within the keytar body 14, but other depths may be used.

The locking mechanism includes a pair of locking members 40 biased outwardly from each other via a spring 42. The locking members 40 include finger holds 44, which a user squeezes together to release the locking mechanism permitting the door 34 to be opened. Each locking member 40 includes a beveled tongue 46 that engages reliefs 48 in the keytar body 14 to lock the door 34 shut.

The interior side of the door 34 includes a compressable layer 50 that deforms to capture the tablet computer 29 against the lip 33 of the keytar body 14.

Referring now to FIG. 6, a diagram of the electronic circuit of the keytar 10 is shown generally at 52. A microprocessor 54 with an integrated high-speed data controller (such as a USB controller) communicates with and authenticates the tablet computer 29 to enable features through an authentication chip 56, if needed. The microprocessor 54 also reads the state of the keytar controls 58 and converts them to messages (such as Core MIDI format) that are transmitted to the tablet computer 29 to trigger actions such as determining pitch of the note being played, applying audio effects like distortion, or bending pitch. Software running on the tablet computer 29 receives the messages and generates the audio output in response to the messages received. The generated audio of the tablet computer 29 may be transmitted digitally via the high-speed data controller (integrated with the microprocessor 54) or out a standard analog line output (not shown) equipped on most tablet computers 29. Alternatively, the audio may be outputted in MIDI format as further described below.

The microprocessor 54 constantly scans the state of the keytar controls 58 (such as drum pads and keyboard keys). Each control 58 may be read by an individual port pin of the microprocessor 54. Alternatively, each control 58 can be formed into a matrix of rows and columns and read by a smaller number of microprocessor 54 pins, as is known in the art.

Audio from the tablet computer 29 is outputted digitally through the high-speed data controller integrated with the microprocessor 54. Digital audio transmitted via the high-speed data controller is passed through a digital-to-analog converter 60. The digital-to-analog converter 60 is connected to one or more connectors 62, such as XLR jacks, ¼″ jack, ⅛″ jack, RCA jacks, or other audio connectors. The analog output of the digital-to-analog converter 60 may also be passed through a differential operational amplifier 64, which may include an optional volume control, prior to being passed transmitted to the connectors 62.

Alternatively, audio may be outputted from the tablet computer 29 through the built-in analog outputs included on most commercial tablet computers 29 as is known in the art.

Each keytar control 58 has a particular MIDI note assigned to it. When the microprocessor 54 detects that a particular control 58 has been activated, it sends a MIDI note “On” signal to the keytar's MIDI outputs, which can be traditional 5-pin MIDI 66 or USB MIDI via a USB interface 68. MIDI output may also be transmitted from the tablet computer 29 to the keytar's MIDI outputs

To measure the tilt of the keytar 10, an accelerometer 70 is read by the microprocessor 54 through an analog to digital converter 72. The value of the accelerometer 70 is converted into a MIDI continuous controller value by the microprocessor 54, which may be transmitted to the tablet computer 29 for additional sound processing (and conversion to audio outputted through the connectors 62) or may be outputted via the MIDI outputs 66, 68 to control an external synthesizer or computer.

Therefore, the improved keytar solves the problems of the prior art by providing a keytar that includes a dock for a tablet computer, integrated drum pads and accelerometer functions, which makes the keytar a more versatile instrument. Because the improved keytar is more versatile it breathes new life into an instrument that has been considered an oddity in the commercial market. The improved keytar will make this old instrument into a staple instrument of future bands.

It would be appreciated by those skilled in the art that various changes and modifications can be made to the illustrated embodiments without departing from the spirit of the present invention. All such modifications and changes are intended to be within the scope of the present invention.

What is claimed is:

1. A keytar, comprising:
a keyboard body having a front, back, left side, and right side, the keyboard body having a cavity formed therein sized and dimensioned to receive a tablet computer therein;
a piano-style keyboard on the front of the keyboard body having a plurality of keys;
a neck extending from one of the right side and the left side of the keyboard body;
an electronic circuit electrically connected to the piano-style keyboard and to the tablet computer, the electronic circuit configured and arranged to scan the keys of the piano-style keyboard and transmit presses of the keys to the tablet computer.

2. The keytar of claim 1, wherein the electronic circuit is configured and arranged to generate a MIDI note signal corresponding to the state each of the plurality of keys and transmit the MIDI note signal to the tablet computer.

3. The keytar of claim 1, further comprising a plurality of drum pads on the front of the keyboard body, the drum pads electrically connected to the electronic circuit, the electronic circuit further configured and arranged to scan the state of each of the plurality of drum pads and generate a MIDI note signal corresponding to the state each of the plurality of drum pads and transmit the MIDI note signal to the tablet computer.

4. The keytar of claim 1, further comprising an accelerometer electrically connected to the electronic circuit, the accelerometer configured and arranged to detect movement of the keyboard body and generate a signal corresponding thereto, the microprocessor configured and arranged to generate a MIDI continuous control signal corresponding to the signal generated by the accelerometer.

5. The keytar of claim 1, wherein the neck extends from the left side of the keyboard body.

6. The keytar of claim 1, wherein the keyboard body further comprises an edge on a front of the keyboard body defining an opening into the cavity, the edge having a thickness forming a lip into the opening wherein the lip is configured and arranged to be received partially over the tablet computer

7. The keytar of claim 6, further comprising a door attached to a rear of the keytar body, the door movable between an open position revealing a second opening into the cavity and a closed position blocking the second opening shut, the door further configured and arranged to compress the tablet computer against an interior portion of the lip when in the closed position.

8. The guitar controller of claim 7, wherein the door further comprises a compressable layer configured and arranged to press against the tablet computer.

9. The guitar controller of claim 7, further comprising a locking mechanism configured and arranged to lock the door in the closed position.

10. The guitar controller of claim 7, wherein the locking mechanism comprises at least one spring-biased member.

11. The guitar controller of claim 10, wherein the at least one spring-biased member slides within the door and into the body to lockably engage with the body when the door is in the closed position.

12. The guitar controller of claim 10, wherein the locking mechanism comprises two spring-biased members.

13. A keytar, comprising:
a keyboard body having a front, back, left side, and right side, the keyboard body having a cavity formed therein sized and dimensioned to receive a tablet computer therein;
a piano-style keyboard on the front of the keyboard body having a plurality of keys;
a plurality of drum pads on the front of the keyboard body;
a neck extending from one of the right side and the left side of the keyboard body;
an electronic circuit electrically connected to the piano-style keyboard, plurality of drum pads, accelerometer and to the tablet computer, the electronic circuit to generate a MIDI note signal corresponding to the state each of the plurality of keys and plurality of drum pads and transmit the MIDI note signal to the tablet computer;
the electronic circuit further configured and arranged to generate a MIDI continuous control signal corresponding to the signal generated by the accelerometer and transmit the MIDI continuous controller value to the tablet computer.

14. The keytar of claim 13, wherein the keyboard body further comprises an edge on a front of the keyboard body defining an opening into the cavity, the edge having a thickness forming a lip into the opening wherein the lip is configured and arranged to be received partially over the tablet computer

15. The keytar of claim 14, further comprising a door attached to a rear of the keytar body, the door movable between an open position revealing a second opening into the cavity and a closed position blocking the second opening shut, the door further configured and arranged to compress the tablet computer against an interior portion of the lip when in the closed position.

16. The guitar controller of claim 15, wherein the door further comprises a compressable layer configured and arranged to press against the tablet computer.

17. The guitar controller of claim 15, further comprising a locking mechanism configured and arranged to lock the door in the closed position.

18. The guitar controller of claim 17, wherein the locking mechanism comprises at least one spring-biased member.

19. The guitar controller of claim 18, wherein the at least one spring-biased member slides within the door and into the body to lockably engage with the body when the door is in the closed position.

20. The guitar controller of claim 17, wherein the locking mechanism comprises two spring-biased members.

21. A keytar, comprising:
a keyboard body having a front, back, left side, and right side, the keyboard body having a cavity formed therein sized and dimensioned to receive a tablet computer therein;
an edge on a front of the keyboard body defining an opening into the cavity, the edge having a thickness forming a lip into the opening wherein the lip is configured and arranged to be received partially over the tablet computer;
a door attached to a rear of the keytar body, the door movable between an open position revealing a second opening into the cavity and a closed position blocking the second opening shut, the door further configured and arranged to compress the tablet computer against an interior portion of the lip when in the closed position.
a piano-style keyboard on the front of the keyboard body having a plurality of keys;
a neck extending from one of the right side and the left side of the keyboard body;
an electronic circuit electrically connected to the piano-style keyboard and to the tablet computer, the electronic circuit configured and arranged to scan the keys of the piano-style keyboard and transmit presses of the keys to the tablet computer.

22. The guitar controller of claim 21, wherein the door further comprises a compressable layer configured and arranged to press against the tablet computer.

23. The guitar controller of claim 21, further comprising a locking mechanism configured and arranged to lock the door in the closed position.

24. The guitar controller of claim 21, wherein the locking mechanism comprises at least one spring-biased member.

25. The guitar controller of claim 24, wherein the at least one spring-biased member slides within the door and into the body to lockably engage with the body when the door is in the closed position.

26. The guitar controller of claim 24, wherein the locking mechanism comprises two spring-biased members.

27. The keytar of claim 21, wherein the electronic circuit is configured and arranged to generate a MIDI note signal corresponding to the state each of the plurality of keys and transmit the MIDI note signal to the tablet computer.

28. The keytar of claim 21, further comprising a plurality of drum pads on the front of the keyboard body, the drum pads electrically connected to the electronic circuit, the electronic circuit further configured and arranged to scan the state of each of the plurality of drum pads and generate a MIDI note signal corresponding to the state each of the plurality of drum pads and transmit the MIDI note signal to the tablet computer.

29. The keytar of claim 21, further comprising an accelerometer electrically connected to the electronic circuit, the accelerometer configured and arranged to detect movement of the keyboard body and generate a signal corresponding thereto, the microprocessor configured and arranged to generate a MIDI continuous control signal corresponding to the signal generated by the accelerometer.
